(19) United States
(12) Patent Application Publication
(10) Pub. No.: US 2022/0274356 A1
(43) Pub. Date: Sep. 1, 2022

(54) PROCESS FOR CASTING A PLATE-SHAPED COMPONENT AND DEVICE FOR CARRYING OUT THE PROCESS

(71) Applicant: BBG GmbH & Co. KG, Mindelheim (DE)

(72) Inventors: Gerhard Hörtrich, Sontheim (DE); Bernhard Satzger, Bad Wörishofen (DE)

(21) Appl. No.: 17/682,318

(22) Filed: Feb. 28, 2022

(30) Foreign Application Priority Data
Mar. 1, 2021 (DE) 102021104864.8

(51) Int. Cl. B29C 70/68; B29C 70/84; B29C 70/72

(52) U.S. Cl. CPC B29C 70/681; B29C 70/84; B29C 70/72; B29K 2709/08

(57) ABSTRACT

A method of encapsulating a plate-shaped component, in particular a glass cover for a vehicle sliding roof, comprises inserting the component and an insertion part to be connected to said component into a mold cavity; fixing the insertion part in the mold cavity by applying a holding force that is directed substantially transversely to a normal to the component; and encapsulating a part region of the component in the mold cavity.

The invention relates to a method of encapsulating a plate-shaped component and to an apparatus for carrying out the method.

The recasting or foam coating (also designated as encapsulation in English) of plate-shaped components is generally known. For example, glass covers provided for a vehicle sliding roof or for a fixed integration in a vehicle roof are encapsulated with a liquid plastic, for example polyurethane (PUR), to be able to connect said glass covers to a mechanical system of a vehicle roof. For this purpose, the plate-shaped component can be connected through the encapsulation to an insertion part, for example to a retaining bracket, that is usually provided with a connection structure intended for the connection to the mechanical system.

The latest development in the field of vehicle sliding roofs is that ever larger panoramic roofs are being marketed. In recent times, this has necessitated the use of increasingly longer glass covers and insertion parts. The precise encapsulation and sealing of the insertion parts are thereby made more difficult. In addition, the insertion parts are usually cranked along their longitudinal direction of extent. The geometry thereby produced additionally makes the encapsulation and sealing even more difficult.

It is the underlying object of the invention to provide a method of encapsulating a plate-shaped component and an apparatus for carrying out the method, said apparatus enabling a secure holding of the insertion part during the encapsulation.

This object is satisfied by the subjects of the independent claims. Advantageous embodiments are the subject of the dependent claims and are indicated in the description and the drawings.

The method in accordance with the invention serves to encapsulate a plate-shaped component, in particular a glass cover for a vehicle sliding roof, and comprises the steps:

inserting the component and an insertion part to be connected to said component into a mold cavity;

fixing the insertion part in the mold cavity by applying a holding force that is directed substantially transversely to a normal to the component; and

encapsulating a part region of the component in the mold cavity.

Instead of encapsulation, the method described above is also suitable for the foam coating or overmolding of components. Where the present application speaks of encapsulation, this also includes the foam coating and overmolding with thermosetting materials or thermoplastic polymers.

Plate-shaped components are, for example, glass covers for a vehicle roof, in particular large-area glass covers, that are, for example, provided for a particularly large-area panoramic sliding roof or for a fixedly integrated panoramic roof. Such plate-shaped components usually have an upper side, a lower side disposed opposite the upper side, and an outer margin that connects the upper side to the lower side. Where reference is made in this application to the “normal to the component”, this is to be understood as the normal, i.e. the perpendicular, to the upper side or to the lower side.

The holding force is thus directed transversely to the normal to the component, i.e. transversely to the upper side or lower side. Consequently, the line of action of the holding force extends approximately in parallel with the upper side or the lower side.

The insertion part is in particular a rigid part and can, for example, be a retaining bracket and can be provided with one or more cranked portions along its longitudinal direction of extent. The insertion part can in particular have a length in the direction of the longitudinal direction of extent of up to approximately 1 m, wherein the present invention generally also enables the attachment of even longer insertion parts. The insertion part can have a connection section that is provided with a connection structure to connect the encapsulated component to a mechanical system, for example to the mechanical system of a vehicle sliding roof, or to a vehicle roof frame by means of the retaining bracket. The connection structure can, for example, have openings for a screwing to the mechanical system or to the vehicle roof frame, wherein the openings can be punched into or drilled into the insertion part.

During the encapsulation, the insertion part or at least a section of the insertion part to be encapsulated, designated as the fastening section in the following, is surrounded by a medium, for example polyurethane (FUR), a thermoplastic elastomer (TPE), or polyvinyl chloride (PVC). The problem here is that the insertion part can be moved away from the component by the pressure of the medium, in particular in the direction of the normal to the component, that is approximately perpendicular to the component. This can, for instance, take place in that the medium pushes between the component and the insertion part and thereby effects a buoyancy force on the insertion part or if a force is applied to the insertion part during the fixing or sealing that is directed oppositely to the normal to the component and that results in a displacement of the insertion part.

Since the insertion part is fixed by a force acting substantially transversely to a normal to the component, it is ensured that the insertion part is securely held at one point within the mold cavity during the encapsulation so that it is not unintentionally moved by the medium or due to the selected fixing variant or sealing variant. It is understood that the holding force in particular acts continuously on the insertion part for this purpose. The encapsulation can thereby be implemented very precisely.

The insertion part can be fixed by means of holding forces acting at two sides on the insertion part, in particular on a section not to be encapsulated. The insertion part can in particular be fixed by means of holding forces that act at oppositely disposed sides of the insertion part and that are directed in opposite directions. A slipping or displacement of the insertion part by the holding forces is thereby avoided and the insertion part is securely held.

The insertion part can, for example, be pneumatically fixed in that a force generated by means of compressed air is used as the holding force. A generation of the holding force by means of compressed air can be implemented with little effort and small space requirements and is therefore particularly well suited for the use in the method.

The insertion part can be fixed by filling at least one elastically deformable chamber of a fixing apparatus with compressed air. The filling can take place with a compressed air supply that in particular has a compressed air valve and a valve for applying a vacuum. Since the elastically deformable chamber is acted on by the introduced compressed air, whose pressure can amount to approximately 2 bar to 8 bar, preferably approximately 4 bar to 6 bar, the chamber is inflated so that a wall surrounding the chamber arches outwardly and contacts the insertion part. Due to the pressure present in the chamber and acting on the wall, the holding force can thus be applied to the insertion part that is thereby simultaneously sealed with respect to the medium.

In an advantageous embodiment, the chamber can be acted on by a vacuum to release the fixing apparatus after the hardening of a medium. The vacuum generates a removal force to be able to release the fixing apparatus from the insertion part after the encapsulation and to reduce the wear. The vacuum furthermore facilitates a return to the original shape of the fixing apparatus. The insertion of a new insertion part for a further encapsulation process is thereby considerably facilitated and the service life of the fixing apparatus is increased since there is no contact with the insertion part, and thus no mechanical abrasion, on the removal of the fixing apparatus due to the vacuum. At the same time, the fixing apparatus protects the insertion part from damage during the removal.

The connection section of the insertion part can be sealed with respect to the medium by the fixing apparatus. PUR in particular has a very low viscosity before the hardening that is approximately comparable to that of water. In addition, the medium, in particular PUR, usually has very good adhesive properties. The subsequent removal is thereby made much more difficult. Furthermore, insertion parts can be provided with coatings, for example a cathodic dip painting (CDP), that may be damaged during the subsequent removal. Since the fixing apparatus is also assigned the function of sealing the insertion part in addition to the function of fixing, the connection section of the insertion part can be kept free of the medium so that these difficulties are avoided.

An apparatus in accordance with the invention serves to carry out the previously described method and has at least two molding tools that together bound a mold cavity. The apparatus further comprises a fixing apparatus for fixing the insertion part in the mold cavity by applying, in particular continuously applying, a holding force that is directed substantially transversely to a normal to the component. In this respect, this indication of direction refers to how a component is to be arranged in the apparatus as intended.

The fixing apparatus can be configured to exert a holding force acting at two sides on the insertion part, wherein the fixing apparatus can in particular be configured to engage at oppositely disposed sides of the insertion part with oppositely directed holding forces.

In an advantageous embodiment, the fixing apparatus can be configured to pneumatically fix the insertion part in that a force generated by means of compressed air is used as the holding force.

The apparatus can be provided with at least one elastically deformable chamber for fixing the insertion part by filling the chamber with compressed air, for example approximately 2 bar to approximately 8 bar, in particular approximately 4 bar to approximately 6 bar. The fixing apparatus can be provided with a compressed air generation to fill the chamber or to apply a negative pressure to it.

In an advantageous embodiment, the fixing apparatus can have at least one inflatable seal that is provided with the chamber and that, in an inflated state, is suitable for applying the holding force to the insertion part and for sealing a connection section of the insertion part with respect to the medium. For example, the seal can be produced by means of extrusion or by 3D printing and can, for example, consist of silicone, an ethylene-propylene-diene rubber (EPDM), or a thermoplastic elastomer (TPE). Furthermore, the fixing apparatus can have one holding rail per seal, which holds the respective seal during the encapsulation, and/or a cover that bounds the seal in the respective holding rail. The holding rail and the cover can consist of metal, for example.

The seal can have a contact surface. The contact surface is configured to contact the insertion part, in particular the connection section, in the inflated state of the seal and to apply the holding force to the insertion part in order to fix the insertion part.

The contact surface can be provided with a profiled surface. The profiled surface can, for example, be provided with elevated portions and depressions that can in particular alternate with one another at equal spacings. The elevated portions and depressions can either extend at right angles from the surface or be inclined with respect to the surface. The profiled surface can in particular have a sawtooth profile.

The apparatus can in particular have two inflatable seals, namely a first inflatable seal and a second inflatable seal for engaging at oppositely disposed sides of the connection section of the insertion part and for applying oppositely directed holding forces to the insertion part.

In an advantageous embodiment, contact surfaces of the first and the second seal can in this respect be provided with profiled surfaces that are suitable for engaging into one another. It is thereby brought about that, in the inflated state, i.e. during the encapsulation, the two seals are placed at a free end of the insertion part around this free end in the longitudinal direction of said insertion part and engage into one another there. The free end is thereby also reliably sealed so that no excess medium can exit.

The invention will be explained by way of example in the following with reference to an advantageous embodiment. In the drawings, which schematically illustrate the embodiments,

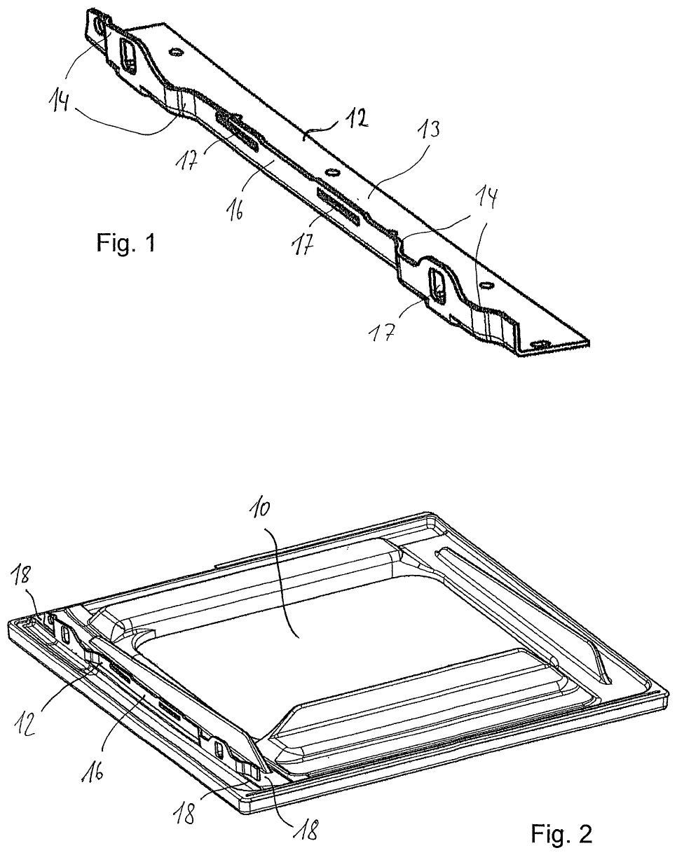

FIG. 1 shows a perspective view of an insertion part;

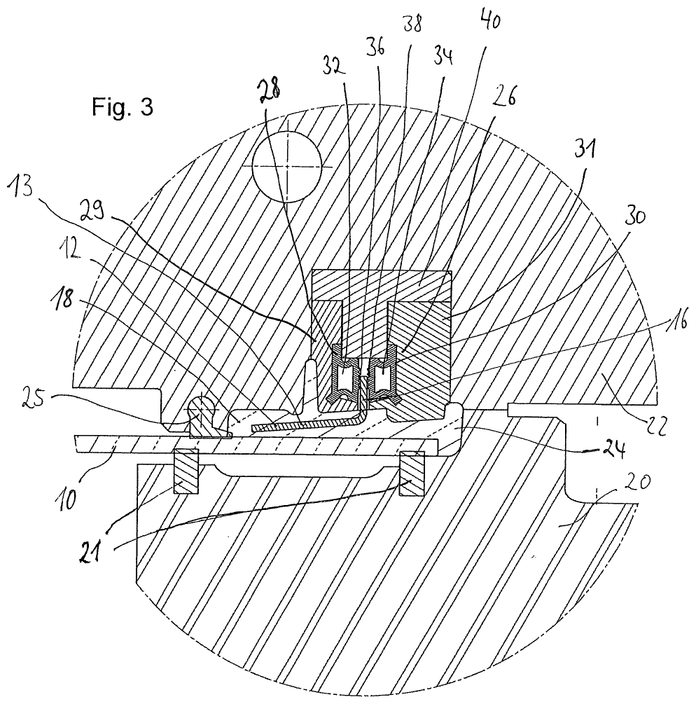

FIG. 2 shows a perspective view of a glass cover connected to an insertion part by means of the method in accordance with the invention;

FIG. 3 shows a section of a cross-sectional view of an apparatus provided with two elastic fixing elements in accordance with an embodiment;

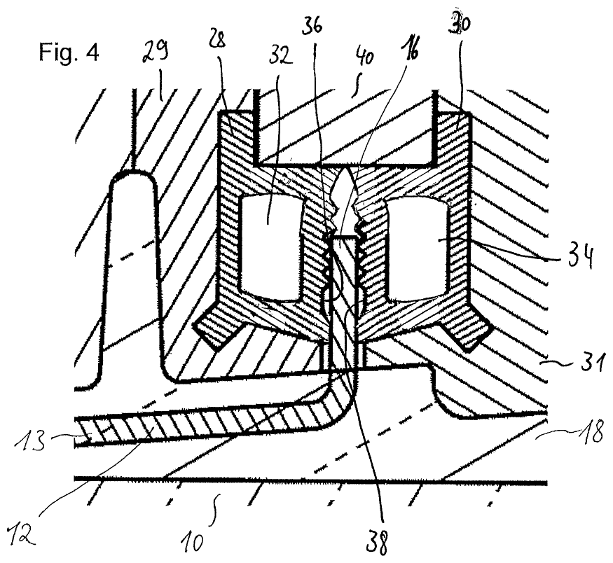

FIG. 4 shows an enlarged section of the cross-sectional view of FIG. 3 in which the elastic fixing elements are shown in a pressurized state; and

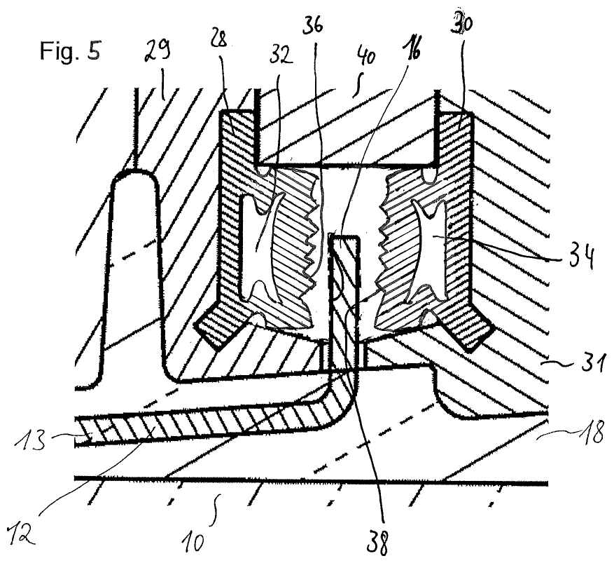

FIG. 5 shows the enlarged section of FIG. 4 in which the elastic fixing elements are shown in a state in which a vacuum is generated in the chambers.

FIG. 1 shows by way of example a rigid insertion part 12 that is configured as a retaining bracket. The insertion part 12 has a fastening section 13 and a connection section 16. The fastening section 13 is provided to be encapsulated with a medium during an encapsulation process and thus serves to fasten the insertion part 12 to a plate-shaped component 10 shown in FIG. 2, for example, to a glass cover for a vehicle sliding roof. The connection section 16 has a connection structure, for example, a plurality of openings 17 that are provided to connect the insertion part 12 to a mechanical system of a vehicle sliding roof, for example.

The connection section 16 of the insertion part 12 is provided with a plurality of cranked portions 14 along its longitudinal direction of extent.

It can be seen from FIG. 2 that the component 10 is connected to the insertion part 12 by the hardened medium 18. In this respect, the insertion part 12 with the connection section 16 projects from the medium 18. The manufacture of the unit shown in FIG. 2 with the component 10 and the insertion part 12 will be described in the following with reference to the apparatus shown in FIGS. 3 and 4.

As FIG. 3 shows, the apparatus comprises a lower molding tool 20 and an upper molding tool 22, which is disposed on the lower molding tool 20, that define a mold cavity 24.

The component 10 and the insertion part 12, which can be pre-positioned and pre-fixed by means of magnets and/or pins, are inserted into the mold cavity 24. In this respect, the component 10 is disposed on the lower molding tool 20 and contacts the vacuum seals 21 between which a vacuum is generated to prevent a slipping of the component 10. Thus, the component 10 is positioned in the mold cavity 24 due to the vacuum.

The region of the mold cavity 24 into which the medium 18 is inserted is bounded outwardly by the component 10, the two molding tools 20, 22, a seal 25, and by holding rails 29, 31 that will be looked at in more detail in the following. The component 10 projects with its marginal region into this region of the mold cavity 24, as does the fastening section 13 of the insertion part 12.

A fixing apparatus 26 comprises two elastic fixing elements 28, 30 and the two holding rails 29, 31, in each of which one of the elastic fixing elements 28, 30 is received. A support 40 for the holding rails 29, 31 is disposed on the holding rails 29, 31 and the elastic fixing elements 28, 30 and adjoins the upper molding tool 22. In addition, the support 40 acts as a spacer between the two holding rails 29, 31, and thus between the two elastic fixing elements 28, 30.

The two elastic fixing elements 28, 30 consist of an elastically deformable material, in particular silicone, and each have a chamber 32, 34 and a contact surface 36, 38 having a surface profiled in the manner of a sawtooth. The two contact surfaces 36, 38 are spaced apart by a gap into which the connection section 16 of the insertion part 12 projects.

The encapsulation of the component 10 takes place as follows: After the component 10, the insertion part 12, and the elastic fixing elements 28, 30 comprising the holding rails 29, 31 have been inserted into the mold cavity 24 as shown in FIGS. 3 and 4, the chambers 32, 34 of the two elastic fixing elements 28, 30 are acted on by compressed air of, for example, approximately 2 bar to approximately 8 bar, in particular approximately 4 bar to approximately 6 bar, by means of an air connection, not shown. In this respect, the chambers 32, 34 expand so that the elastic wall of the elastic fixing elements 28, 30 that surrounds the chambers 32, 34 arches outwardly. The hollow spaces produced in FIG. 3 at the upper side and at the lower side of the elastic fixing elements 28, 30 by compensation grooves are closed by the outwardly arching material of the elastic fixing elements 28, 30, see FIG. 4. The material also arches into the gap between the two elastic fixing elements, as likewise shown in FIG. 4, and thereby fixedly contacts the connection section 16 of the insertion part 12.

The two elastic fixing elements 28, 30 thereby cause holding forces whose lines of action extend substantially transversely to a normal to the component 10 over its total length and which continuously act in an oppositely directed manner at oppositely disposed sides of the insertion part 12 to fix the insertion part 12 and to secure it against displacement, in particular on the insertion of the medium 18. On the other hand, a sealing of the connection section 16 against the medium 18 is effected.

The profiling of the contact surfaces 36, 38 also causes them to be placed at a free end around this free end in the longitudinal direction of the insertion part 12 and to engage into one another there. A careful sealing of the free end is thereby also ensured.

Subsequently, the medium 18 is inserted into the corresponding region of the mold cavity 24, as shown in FIGS. 3 and 4, and in so doing surrounds the component 10 and the insertion part 12 in accordance with the shape predefined by the molding tools 20, 22, the seal 25, and the holding rails 29, 31, wherein the connection section 16 remains free of the medium 18.

After the medium 18 has hardened, a vacuum is generated in the chambers 32, 34 as shown in FIG. 5, whereby the contact surfaces 36, 38 of the elastic fixing elements 28, 30 release from the insertion part 12 and the elastic fixing elements 28, 30 approximate their original shape. The insertion of a new insertion part 12 for a further encapsulation process is thereby facilitated. In addition, the application of a negative pressure increases the service life of the elastic fixing elements 28, 30 since, on the pulling out of the elastic fixing elements 28, 30, the retaining force acting on the elastic fixing elements 28, 30 is reduced by the previous application of the negative pressure. The elastic fixing elements 28, 30 are therefore released from the insertion part 12 after the encapsulation due to the vacuum so that no mechanical abrasion results, and thus a reduced wear results, on the removal of the fixing elements 28, 30. At the same time, the fixing apparatus 26 protects the insertion part 12 from damage during the removal.

The embodiments of the method and of the apparatus described herein have in common that a plate-shaped component 10 can be encapsulated by them, wherein, during the encapsulation, a secure holding of the insertion part 12 is ensured, on the one hand, and the insertion part 12 is reliably sealed against a medium, on the other hand. With this new method of fixing and sealing, considerably larger tolerances of the insertion part 12 can also be compensated and a plastic-free connection surface can thus be reliably produced.

### REFERENCE NUMERAL LIST

10 plate-shaped component
12 insertion part
13 fastening section
14 cranked portion
16 connection section
17 opening
18 medium
20 molding tool
21 vacuum seal
22 molding tool
24 mold cavity
25 seal
26 fixing apparatus
28 elastic fixing element
29 holding rail
30 elastic fixing element
31 holding rail
32 chamber
34 chamber
36 contact surface
38 contact surface
40 support

1-17. (canceled)

18. A method of encapsulating a plate-shaped component, the method comprising the steps of:
inserting the component and an insertion part to be connected to said component into a mold cavity;
fixing the insertion part in the mold cavity by applying a holding force that is directed substantially transversely to a normal to the component; and
encapsulating a part region of the component in the mold cavity.

19. The method in accordance with claim 18, wherein the plate-shaped component is a glass cover for a vehicle sliding roof.

20. The method in accordance with claim 18, wherein the insertion part is fixed by means of holding forces acting at two sides on the insertion part.

21. The method in accordance with claim 18, wherein the insertion part is fixed by means of oppositely directed holding forces acting at oppositely disposed sides of the insertion part.

22. The method in accordance with claim 18, wherein the insertion part is pneumatically fixed.

23. The method in accordance with claim 18, wherein the insertion part is fixed by filling at least one elastically deformable chamber of a fixing apparatus with compressed air.

24. The method in accordance with claim 23, wherein the chamber is acted on by a vacuum to release the fixing apparatus after the hardening of a medium.

25. The method in accordance with claim 23, wherein a connection section of the insertion part is sealed with respect to a medium by the fixing apparatus.

26. An apparatus for carrying out a method of encapsulating a plate shaped component, the apparatus comprising:
at least two molding tools that together bound a mold cavity; and
a fixing apparatus for fixing the insertion part in the mold cavity by applying a holding force that is directed substantially transversely to a normal to the component.

27. The apparatus in accordance with claim 26, wherein the fixing apparatus is configured to exert a holding force acting at two sides on the insertion part.

28. The apparatus in accordance with claim 26, wherein the fixing apparatus is configured to engage at oppositely disposed sides of the insertion part with oppositely directed holding forces.

29. The apparatus in accordance with claim 26, wherein the fixing apparatus is configured to pneumatically fix the insertion part.

30. The apparatus in accordance with claim 26, further comprising at least one elastically deformable chamber for fixing the insertion part by filling the chamber with compressed air.

31. The apparatus in accordance with claim 29, wherein the fixing apparatus has at least one inflatable seal that is provided with the chamber and that, in an inflated state, is suitable for applying the holding force to the insertion part and for sealing a connection section of the insertion part with respect to a medium.

32. The apparatus in accordance with claim 31, wherein the seal has a contact surface that is configured to contact the insertion part in the inflated state of the seal and to apply the holding force to said insertion part.

33. The apparatus in accordance with claim 32, wherein the contact surface of the seal is configured to contact a connection section of the insertion part.

34. The apparatus in accordance with claim 32, wherein the contact surface is provided with a profiled surface.

35. The apparatus in accordance with claim 26, further comprising a first and a second inflatable seal for engaging at oppositely disposed sides of the connection section of the insertion part and for applying oppositely directed holding forces to the insertion part.

36. The apparatus in accordance with claim 35, wherein contact surfaces of the first and the second seal are provided with profiled surfaces that are suitable for engaging into one another.
